(19) United States
(12) Patent Application Publication
(10) Pub. No.: US 2007/0044120 A1
(43) Pub. Date: Feb. 22, 2007

(54) Digital television and method for displaying channel change information thereof

(75) Inventor: Jae-hoon Lee, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/353,968

(22) Filed: Feb. 15, 2006

(30) Foreign Application Priority Data
Jun. 15, 2005 (KR) 10-2005-0051515

(51) Int. Cl. H04N 7/16; G06F 3/00; H04N 5/253; G06F 13/00; H04N 5/50; H04N 5/257; H04N 5/445; H04N 9/47

(52) U.S. Cl. 725/38; 725/39; 348/731; 348/100; 725/135

(57) ABSTRACT

The present invention provides a method and apparatus for displaying channel change information of a digital television. The method includes receiving automatic channel change information; changing a channel on the basis of the received automatic channel change information; and generating and displaying original channel returning time information on the basis of time information included in the automatic channel change information. Thus, the present invention provides a digital television and a method for displaying channel change information thereof, in which time to return to an original channel is displayed, thereby providing convenience to a viewer.

### CROSS-REFERENCE TO RELATED APPLICATIONS

This application claims priority from Korean Patent Application No. 10-2005-0051515, filed on Jun. 15, 2005, in the Korean Intellectual Property Office, the disclosure of which is incorporated herein by reference.

### BACKGROUND OF THE INVENTION

1. Field of the Invention

The present invention relates to a digital television and a method for displaying channel change information thereof, and more particularly, to displaying channel change information based on a direct channel change table (DCCT).

2. Description of the Related Art

The broadcasting of television programming in digital format recently began. As compared with analog broadcasting, in digital broadcasting, a video signal and an audio signal are converted into digital signals, and then the digital signal is compressed, packeted and transmitted as a transport stream.

Digital broadcasting standards are selected to be adapted to a variety of countries, respectively. DCCT has been proposed as an extended standard of the program and system information protocol (PSIP) of the advanced television systems committee (ATSC) standard, which has been selected as the digital broadcasting standard in North America. Further, there are similar standards for digital broadcasting that have been selected in Europe or other countries.

Here, the DCCT is a table having information about how to automatically change a channel under a certain condition, which is transmitted and included in the PSIP. According to the DCCT, items taken as channel change conditions are tabulated by codes. For example, the item includes local information, population information, genre information, etc. Further, setting information corresponding to such items is set in a television by a user.

When a digital television receives DCCT information, the received DCCT information is compared with the previously set information related to the DCCT. In the case where the received DCCT information is equal to the previously set information related to the DCCT, the channel is changed according to the DCCT information. Then, when a program of the changed channel is finished, the channel returns to an original channel.

However, in the case where the channel is changed on the basis of the DCCT, it is inconvenient for a user because the user cannot know information about returning to the original channel.

### SUMMARY OF THE INVENTION

Accordingly, it is an aspect of the present invention to provide a digital television and a method for displaying channel change information thereof, in which time to return to an original channel is displayed, thereby providing convenience to a user.

The foregoing and/or other aspects of the present invention can achieved by providing a method for displaying channel change information, the method comprising receiving automatic channel change information; changing a channel on the basis of the automatic channel change information that is received; and generating and displaying original channel returning time information on the basis of time information that is included in the automatic channel change information that is received.

According to an aspect of the present invention, the original channel returning time information comprises information about a program televising time of the channel that is changed on the basis of the automatic channel change information that is received.

According to an aspect of the present invention, the automatic channel change information comprises a direct channel change table (DCCT).

According to an aspect of the present invention, the method further comprises setting user information related to the DCCT, wherein the changing the channel comprises determining whether the DCCT information that is received is identical with the user information that is set, and changing the channel on the basis of the DCCT information if the DCCT information that is received is identical with the user information that is set.

According to an aspect of the present invention, the original channel returning time information includes information about a time that remains until a changed channel returns to an original channel.

The foregoing and/or other aspects of the present invention can achieved by providing a digital television including an automatic channel change function, the digital television comprising a receiver that receives automatic channel change information; an OSD generator; and a controller that changes a channel on the basis of the automatic channel change information that is received, and controls the OSD generator to generate original channel returning time information on the basis of time information that is included in the automatic channel change information that is received.

According to an aspect of the present invention, the original channel returning time information comprises information about a program televising time of the channel that is changed on the basis of the automatic channel change information that is received.

According to an aspect of the present invention, the automatic channel change information comprises a direct channel change table (DCCT).

According to an aspect of the present invention, the digital television further comprises a memory that stores user information related to the DCCT, wherein the controller determines whether the DCCT information that is received is identical with the user information that is set, and changes the channel on the basis of the DCCT information that is received if the DCCT information that is received is identical with the user information that is set.

According to an aspect of the present invention, the digital television further comprises a parsing unit that parses the DCCT information that is received.

According to an aspect of the present invention, the original channel returning time information includes information about a time that remains until a changed channel returns to an original channel.

### BRIEF DESCRIPTION OF THE DRAWINGS

The above and other aspects of the present invention will become apparent and more readily appreciated from the following description of the exemplary embodiments, taken in conjunction with the accompany drawings of which:

FIG. 1 is a control block diagram of a digital television according to an exemplary embodiment of the present invention;

FIG. 2 is a control flowchart of the digital television according to an exemplary embodiment of the present invention;

FIG. 3 shows an example of a directed channel change table (DCCT); and

FIG. 4 shows an on screen display (OSD) image including information about time to change a channel according to an exemplary embodiment of the present invention.

### DETAILED DESCRIPTION OF THE EXEMPLARY EMBODIMENTS OF THE INVENTION

Reference will now be made in detail to the exemplary embodiments of the present invention, examples of which are illustrated in the accompanying drawings, wherein like reference numerals refer to like elements throughout. The exemplary embodiments are described below in order to explain the present invention by referring to the figures.

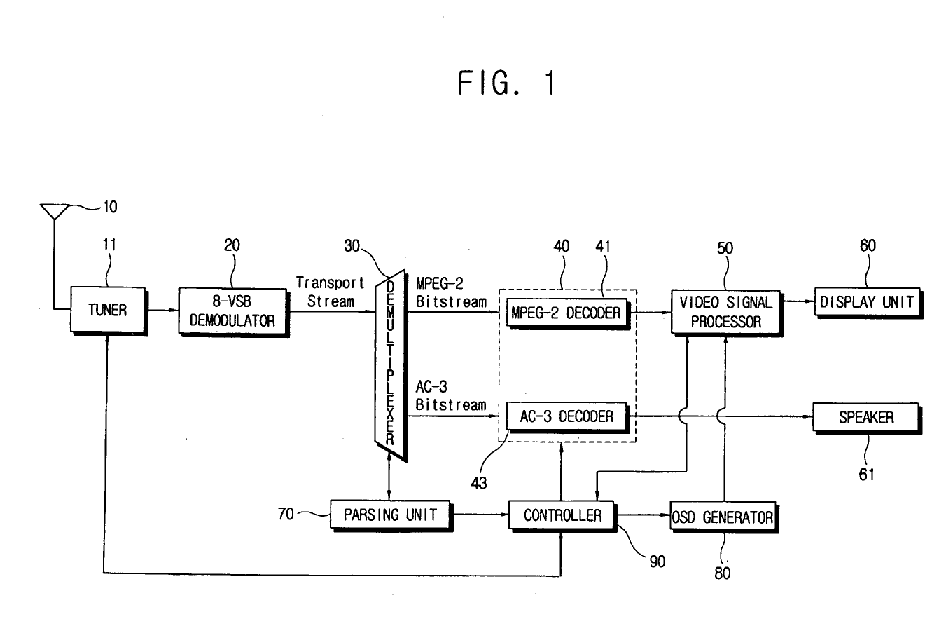

FIG. 1 is a control block diagram of a digital television according to a first exemplary embodiment of the present invention. For reference, the digital television according to the first exemplary embodiment of the present invention receives a broadcasting signal based on the ATSC standard.

As shown in FIG. 1, the digital television according to an embodiment of the present includes an antenna 10, a tuner 11, a 8-vestigial sideband (VSB) demodulator 20, a demultiplexer 30, a decoder 40, a video signal processor 50, a display unit 60, a speaker 61, a parsing unit 70, an on screen display (OSD) generator 80, and a controller 90.

A digital broadcasting signal is transmitted by time-division multiplexing and packeting a video signal, an audio signal and data information into a transport stream.

The tuner 11 tunes the broadcasting signal received through the antenna 10 to a broadcasting signal having a frequency band corresponding to a tuning control signal of the controller 90 (to be described later).

The broadcasting signal of a tuned certain channel is output as the transport stream through a VSB demodulating process, an error correcting process, or the like by the 8-VSB demodulator 20. Then, the broadcasting signal is divided into various appendix data such as the video signal, the audio signal and PSIP information by the demultiplexer 30, and output as a bit stream.

The video data divided through the demultiplexer 30 is decoded by a moving picture experts group (MPEG)-2 decoder 41, and processed by the video signal processor 50, thereby being displayed on the display unit 60. Here, the display unit 60 employs various type display modules such as digital light processing (DLP), a liquid crystal display (LCD), a plasma display panel (PDP), etc. Further, the signal processor 50 includes a scaler for converting the video signal to have a vertical frequency, a resolution, an aspect ration, etc. in accordance with output standards of the display unit 60.

Further, the audio signal is decoded by an audio coding (AC)-3 decoder 43, and output to the speaker 61.

Meanwhile, various appendix data included in the PSIP information divided by the demultiplexer 30 are stored in a predetermined memory (not shown) by a controller 90 according to data tables. Among the appendix data, data for displaying an image is processed through the video signal processor 50, synthesized with a currently tuned video signal, and output to the display unit 60 according to controls of the controller 90. Alternatively, the appendix data is generated as a video signal by the OSD generator 80 (to be described later), and processed by the video signal processor 50 according to the controls of the controller 90.

Here, the PSIP information basically includes a system time table (STT), a master guide table (MGT), a virtual channel table (VCT), a rating region table (RRT), an event information table (EIT), and an ETT (extended text table). Further, the PSIP information includes a DCCT.

DCC information included in the DCCT information is parsed by the parsing unit 70. The parsing unit 70 can be realized by a software program, and embedded in a controller chip such as a micom or the like.

The OSD generator 80 generates original channel returning time information of a direct channel change (DCC) information according to the controls of the micom (to be described later). Here, the original channel returning time information includes information about a program televising time of a channel changed by the DCC function and/or a time remained until a changed channel returns to an original channel. Then, an OSD image including the foregoing information is synthesized with a video signal currently processed through the video signal processor 50, and displayed on the display unit 60.

When the channel is changed by the DCC function, the controller 90 controls the OSD generator 80 to generate the OSD image corresponding to the original channel returning time information on the basis of starting and ending time information included in the DCCT parsed by the parsing unit 70. Here, the controller 90 is realized by the controller chip such as the micom or the like.

The original channel returning time information related to the DCC and displayed as the OSD image is displayed in a predetermined displaying region where the OSD image is not obstructive to a broadcasting program corresponding to a channel.

Thus, when the channel is changed according to the DCC function, the original channel returning time information is displayed on the displaying region of the display unit 60, so that a user can know that a channel change is based on the DCC function and the user can know the time until return to the original channel, thereby providing convenience to the user.

The digital television according to an exemplary embodiment of the present invention includes a user selection unit (not shown) for allowing a user to select and cancel the DCC function and to input user information about the DCC. Here, the user selection unit includes a menu key (not shown) provided in a wireless remote controller, and a key signal generator (not shown) to generate a key signal corresponding to key manipulation. Alternatively, the user selection unit may be provided as a mouse, a keyboard or the like, or may be provided in a main casing of the digital television.

Here, the user information about the DCC may include postal code information, local information, population information, and genre information. Further, the local situation information may include a country code, a regional code, and a detailed regional code. Also, the population information may include information about sexes, ages, occupations, etc.

Meanwhile, when the DCC function is selected, the controller 90 controls the OSD generator 80 to generate an OSD menu allowing a user to input the user information and the display unit 60 to display the OSD menu thereon. Further, when information corresponding to manipulation of the user selection unit is input, the controller 90 stores the corresponding information. Also, when the DCCT is received, the controller 90 compares the DCC information parsed by the parsing unit 70 with the preset user information, and changes the channel on the basis of the DCCT when the parsed DCC information is identical with the preset user information.

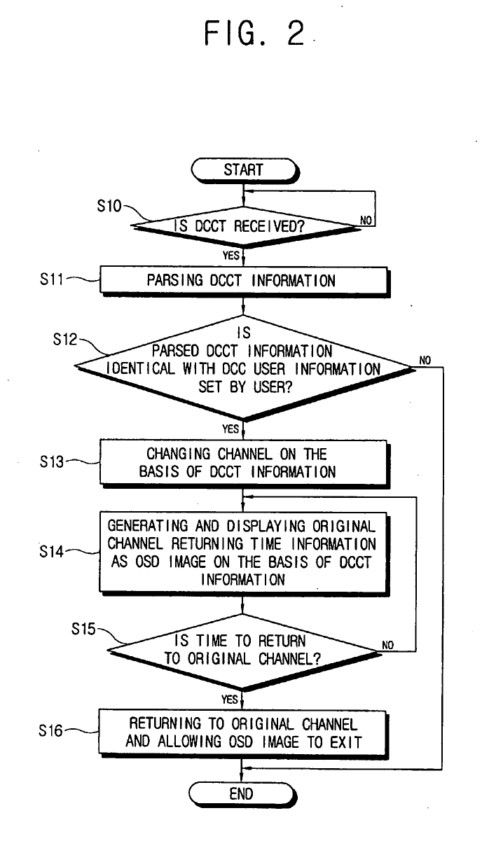

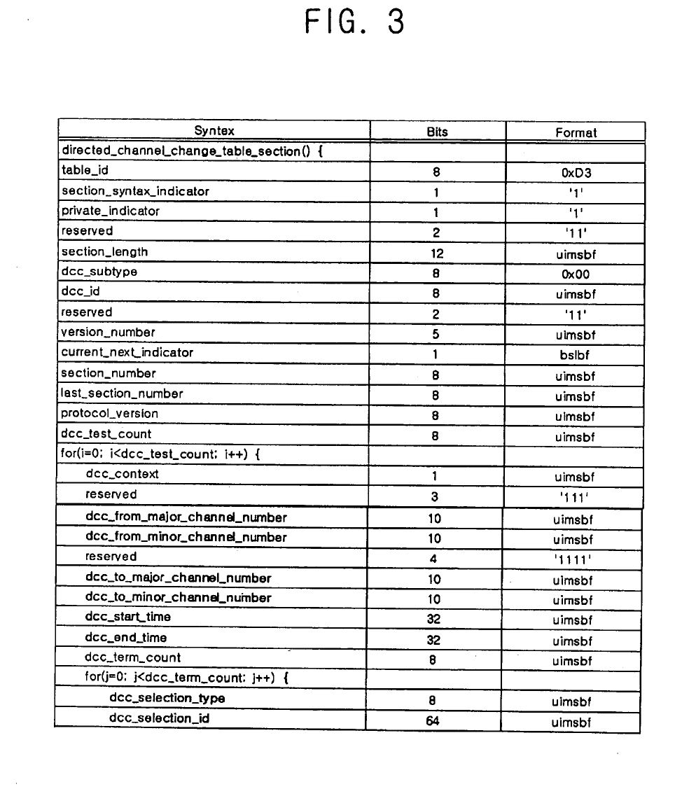

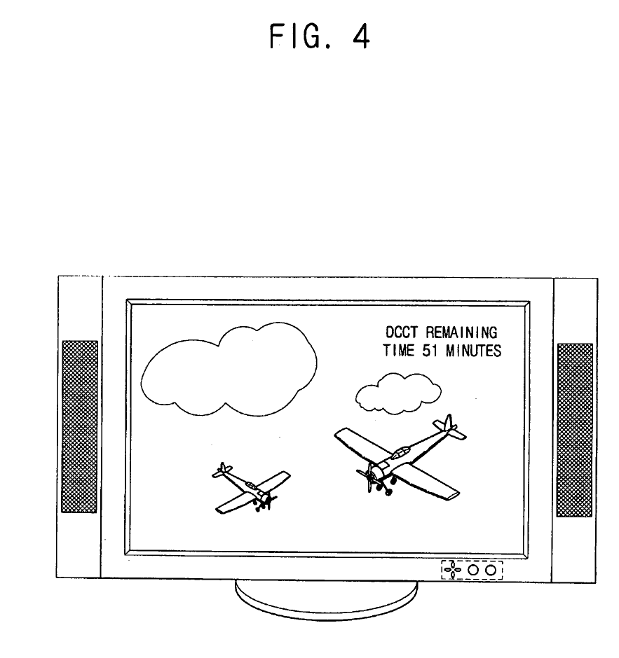

According to an- exemplary embodiment of the present invention, a method of controlling the digital television will be described with reference to FIGS. 2 through 4. FIG. 2 is a control flowchart of the digital television according to an exemplary embodiment of the present invention, FIG. 3 shows an example of a DCCT; and FIG. 4 shows an OSD image including original channel returning time information of the DCC according to an exemplary embodiment of the present invention.

As shown in FIG. 2, at operation S10, the controller 90 determines whether the received PSIP information includes the DCCT information. When the received PSIP information includes the DCCT information, at operation S11 the controller 90 controls the parsing unit 70 to parse the DCC information. At operation S12, the controller 90 compares the parsed DCC information with the preset user information related to the DCC function.

When the parsed DCC information is identical with the preset user information, at operation S13 the controller 90 changes the channel on the basis of DCC channel information and DDC starting time information included in the DCCT.

Referring to the DCCT information of FIG. 3, when a value set by a user is identical (Evaluation True) with dcc_{—selection}_{—id of each dcc}_{—selection type while a user watches virtual channels corresponding to a dcc}_{—from}_{—major}_{—channel}_{—number and a dcc}_{—from}_{—minor}_{—channel}_{—number, the controller 90 controls the channel to be changed to the virtual channels corresponding to the dcc}_{—from}_{—major}_{—channel}_{—number and the dcc}_{—from}_{—minor}_{—channel}_{—number at a dcc}_{—start time, and the virtual channel to return to the original channel.}

Here, the DCC mode is stopped when a user selects another channel before returning to the original channel or when a table (dcc_{—selection}_{—type=}0×0F) for stopping the DCC mode is received.

The dcc_{—selection}_{—type is variously defined. For example, in the case of the postal code, the dcc}_{—selection}_{—type includes} 0×01, 0×02, 0×11 and 0×12. In this case, a dcc_{—selection}_{—id is a postal code value, and operates according to types. Further, the dcc}_{—selection}_{—type related to the DCCT may include the local information (}0×0C, 0×1C), the population information (0×05, 0×06, 0×5, 0×16, and the genre information (0×07, 0×08, 0×17, 0×18). Thus, the controller 90 changes the channel correspondingly when the DCCT information is identical with the user information. On the other hand, when the DCCT information is not identical with the user information, the DCCT is not enabled.

In the case where the preset user information is identical with the received DCC information and the channel is changed at a corresponding start time, at operation S14 the controller 90 controls the OSD generator 80 to generate the original channel returning time information on the basis of the starting time information (dcc_{—start}_{—time) and the ending time information (dcc}_{—end}_{—time) among the DCC information parsed by the parsing unit 70, and display it on the display unit 60. Thus, a user can know the original channel returning time information based on the DCC function.}

FIG. 4 shows an OSD image including original channel returning time information of the DCC, which is generated by the OSD generator 80 and displayed on the display unit 60, according to an exemplary embodiment of the present invention.

As shown in FIG. 4, the original channel returning time information “DCC remaining time 51 minutes” is displayed as the OSD image in a right upper region of the display unit 60. Here, the time information displayed as the OSD image includes information that the DCC function is enabled, time to return to the original channel, or a DCC program televising time. Alternatively, the displaying region and the displaying method may be variously set.

When the original channel returning time based on the DCC function is elapsed at operation S15, the controller 90 controls the channel to return to the original channel, and controls the OSD image including the original channel returning time information to exit at operation S16. Further, when the channel is changed by a user's selection while a user watches the channel changed by the DCC function, the OSD image automatically exits.

In the foregoing exemplary embodiment, the DCCT is based on the ATSC standard, but is not limited to ATSC. For instance, the present invention can be applied to broadcasting standards other than ATSC.

As described above, the present invention provides a digital television and a method for displaying channel change information thereof, in which time to return to an original channel is displayed, thereby providing convenience to the user.

Although a few exemplary embodiments of the present invention have been shown and described, it will be appreciated by those skilled in the art that changes may be made in these exemplary embodiments without departing from the principles and spirit of the invention, the scope of which is defined in the appended claims and their equivalents.

What is claimed is:

1. A method for displaying channel change information, the method comprising:
receiving automatic channel change information;
changing a channel on the basis of the automatic channel change information that is received; and
generating and displaying original channel returning time information on the basis of time information that is included in the automatic channel change information that is received.

2. The method according to claim 1, wherein the original channel returning time information comprises information about a program televising time of the channel that is changed on the basis of the automatic channel change information that is received.

3. The method according to claim 2, wherein the automatic channel change information comprises a direct channel change table (DCCT).

4. The method according to claim 3, further comprising setting user information related to the DCCT,
wherein the changing the channel comprises determining whether the DCCT information that is received is identical with the user information that is set, and changing the channel on the basis of the DCCT information if the DCCT information that is received is identical with the user information that is set.

5. The method according to claim 1, wherein the original channel returning time information includes information about a time that remains until the channel that is changed returns to an original channel.

6. The method according to claim 5, wherein the automatic channel change information comprises a direct channel change table (DCCT).

7. The method according to claim 6, further comprising setting user information related to the DCCT,
wherein the changing the channel comprises determining whether the DCCT information that is received is identical with the user information that is set, and changing the channel on the basis of the DCCT information if the DCCT information that is received is identical with the user information that is set.

8. A digital television including an automatic channel change function, the digital television comprising:
a receiver that receives automatic channel change information;
an OSD generator; and
a controller that changes a channel on the basis of the automatic channel change information that is received, and controls the OSD generator to generate original channel returning time information on the basis of time information that is included in the automatic channel change information that is received.

9. The digital television according to claim 8, wherein the original channel returning time information comprises information about a program televising time of the channel that is changed on the basis of the automatic channel change information that is received.

10. The digital television according to claim 9, wherein the automatic channel change information comprises a direct channel change table (DCCT).

11. The digital television according to claim 10, further comprising a memory that stores user information related to the DCCT,
wherein the controller determines whether the DCCT information that is received is identical with the user information that is set, and changes the channel on the basis of the DCCT information that is received if the DCCT information that is received is identical with the user information that is set.

12. The digital television according to claim 11, further comprising a parsing unit that parses the DCCT information that is received.

13. The digital television according to claim 8, wherein the original channel returning time information includes information about a time that remains until the channel that is changed returns to an original channel.

14. The digital television according to claim 13, wherein the automatic channel change information comprises a direct channel change table (DCCT).

15. The digital television according to claim 14, further comprising a memory that stores user information related to the DCCT,
wherein the controller determines whether the DCCT information that is received is identical with the user information that is set, and changes the channel on the basis of the DCCT information that is received if the DCCT information that is received is identical with the user information that is set.

16. The digital television according to claim 15, further comprising a parsing unit that parses the DCCT information that is received.
